(19) United States
(12) Patent Application Publication
(10) Pub. No.: US 2008/0264996 A1
(43) Pub. Date: Oct. 30, 2008

(54) Trigger Valve for Pneumatic Nail Gun

(76) Inventor: Chin Lung Chang, Taipei Hsien (TW)

Correspondence Address: HDSL, 4331 STEVENS BATTLE LANE, FAIRFAX, VA, 22033, US

(21) Appl. No.: 11/741,828

(22) Filed: Apr. 30, 2007

(51) Int. Cl. B27F 7/17

(52) U.S. Cl. 227/8

(57) ABSTRACT

A nail gun includes an air concentrating chamber and a main air passage, and the trigger valve is disposed between the air concentrating chamber and the main air passage. The trigger valve includes a valve body, a shuttle valve nested in the valve body, a valve base integrated with the valve body, and a valve bar being capable of pressed and released. When the valve bar is pressed to actuate the high pressure air in the air concentrating chamber to drive the shuttle valve to downwardly move, for guiding the high pressure air in the air concentrating chamber into the main air passage to provide necessary energy for hitting nails. When the valve bar is released, the high pressure air in the main air passage are exhausted, so as to actuate the high pressure air in the air concentrating chamber to drive the shuttle valve to upwardly move to reposit.

### BACKGROUND

The present invention relates to trigger valves, and particularly to a trigger valve for being used in a pneumatic nail gun. The trigger valve is capable of guiding compressed high pressure air to provide necessary energy for hitting nails when a trigger of the nail gun is pressed.

In general, a trigger with a trigger valve is installed in a gun body of a pneumatic nail gun, adjacent to an end of a compressed air chamber of the pneumatic nail gun. The user can press or release the trigger to actuate the trigger valve for switching the compressed air passages to drive the hitting rod to downwardly move to hit nails or to upwardly move to reposit.

There are two types of typical conventional trigger valves.

One type of the trigger valve is driven by opening the valve to exhaust compressed high pressure air therein for hitting nails. The related arts, such as TW Patent No. M260376, which discloses a typical trigger valve. When the trigger is pressed, the trigger valve is opened to exhaust the compressed air in a assistant air chamber of a main air valve, to actuate the main air valve to be driven by high pressure air concentrated in a main air chamber, and the compressed air are guided to drive the piston to downwardly move to hit nails.

The other type of the trigger valve is driven by opening the valve to concentrate high pressure therein for hitting nails. The related arts, such as TW Patent No. 439630 and TW Patent No. I263565, each of which discloses a typical trigger valve. When the trigger is pressed, the trigger valve is opened to guide compressed high pressure air therein to actuate a valve member or a cylinder to be opened, for driving the piston to downwardly move to hit nails.

The two types of the trigger valves have different structures and passages. However, the trigger valve disclosed in TW Patent No. 439630 includes a shuttle valve, and a direction of opening the shuttle valve is reverse to a direction of the high pressure air inputting into the valve. That is, the shuttle valve has to overcome a reverse pushing force generated by upper compressed high pressure air when upwardly moves that is driven by pushing force generated by bottom compressed high pressure air, which delay the time of opening the shuttle valve to hit nails. The trigger valve disclosed in TW Patent No. I263565 can overcome these deficiencies, however, this trigger valve has a large number of elements and a complicated structure, which makes the cost unduly high.

Accordingly, what is needed is a trigger valve for pneumatic nail gun that can overcome the above-described deficiencies.

### BRIEF SUMMARY

A trigger valve of a pneumatic nail gun is provided. The nail gun includes an air concentrating chamber and a main air passage. The trigger valve includes a valve body disposed between the air concentrating chamber and the main air passage, which also forms an air groove therein; a valve base fixed to or integrated with a bottom portion of the valve body, the valve base includes a bottom valve hole and at least one air exhausting groove connected with environments; a shuttle valve being driven by compressed high pressure air in the air concentrating chamber, the shuttle valve is nested in the valve body, to divide the air groove into a first air inputting passage connecting with the air concentrating chamber and the main air passage, a second air inputting passage connecting with the air concentrating chamber and the bottom air chamber, a first air exhausting passage connecting with the air exhausting groove and the main air passage, and a second air exhausting passage connecting with the environments via the bottom valve hole; and a valve bar being capable of pressed and released, which is nested between the bottom valve hole and the shuttle valve.

When the valve bar is driven to upwardly move to close the second air inputting passage and open the second air exhausting passage, the shuttle valve is driven to downwardly move by high pressure air in the air concentrating chamber, so as to close the first air exhausting passage and open the first air inputting passage for guiding the high pressure air in the air concentrating chamber into the main air passage. When the valve bar is released to downwardly move to close the second air exhausting passage and open the second air inputting passage, the shuttle valve is driven to upwardly move to reposit by high pressure air in the bottom air chamber via the second air inputting passage, so as to close the first air inputting passage and open the first air exhausting passage for exhausting the high pressure air in the main air passage to environments.

With these configurations, when the trigger is pressed, it can guide the high pressure air in the air concentrating chamber into the main air passage to provide necessary energy for hitting nails. Moreover, the direction of moving of the shuttle valve is the same as the direction of moving of the high pressure air, which increase the agility of the trigger valve during the process of hitting nails. Furthermore, the trigger valve has a simple structure and less number of elements, which lower the cost thereof.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exploded, cross-sectional view of separate elements of a trigger valve according to an exemplary embodiment of the present invention;

FIG. 2 is an assembled, cross-sectional view of the trigger valve of FIG. 1;

FIG. 3 is a schematic, cross-sectional view of the trigger valve of FIG. 1, showing a state of the trigger valve before being pressed;

FIG. 4 is a schematic, cross-sectional view of the trigger valve of FIG. 1, showing a state of a valve bar being driven to upwardly move; and

FIG. 5 is a schematic, cross-sectional view of the trigger valve of FIG. 1, showing a state of a shuttle valve being driven to downwardly move.

### DETAILED DESCRIPTION

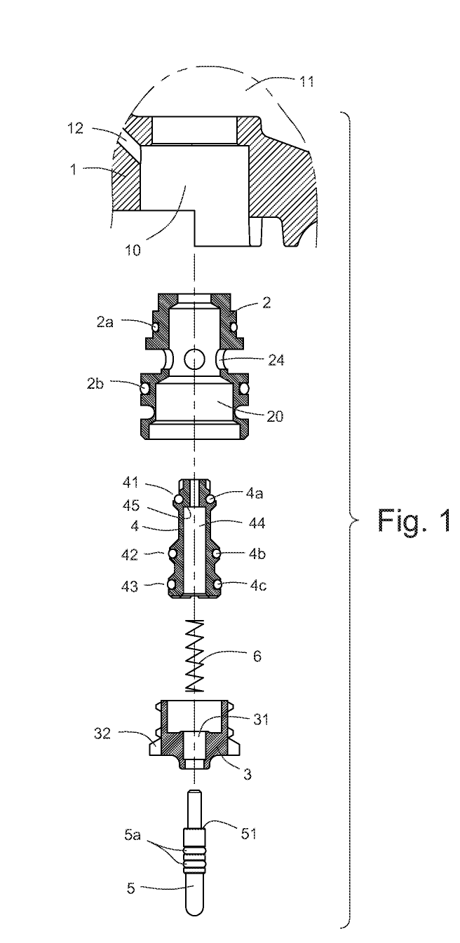

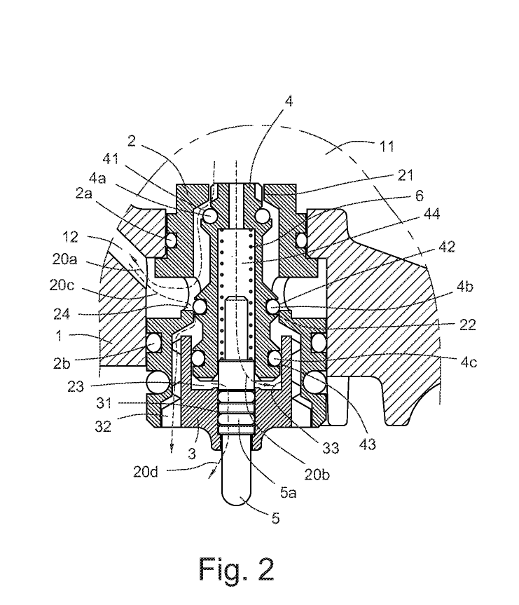

Referring to FIGS. 1-2, FIG. 1 is an exploded, cross-sectional view of separate elements of a trigger valve according to an exemplary embodiment of the present invention, and FIG. 2 is an assembled, cross-sectional view of the trigger valve.

The gun body 1 includes an air compressed chamber 11, a main air passage 12, and a chamber 10 connecting between the compressed chamber 11 and the main air passage 12. The valve body is fixed to the chamber 10 and between the main air passage 12 and the chamber 11.

The valve body 2 includes two air tight rings 2a and 2b disposed at end surfaces thereof. The chamber 11 is used for concentrating air from air supplier and maintain a certain high pressure therein. The main air passage 12 is connected with a cylinder, an air chamber or a passage in the gun body 1. The valve body 2 includes an air groove 20, which is connected with the main air passage 12 via a through hole 24 disposed in the valve body 2. Moreover, the valve body 2 includes a top valve hole 21 connected with the chamber 11, and a middle valve hole 22 connected with the main air passage 12 via the through hole 24.

The trigger valve includes a valve base 3, which is integrated with the valve body 2 and fixed to a bottom portion thereof. The valve base 3 includes a bottom valve hole 31 at a middle portion of the valve base 3, and at least one air exhausting groove 32 disposed at peripheral portion thereof. The air exhausting groove 32 is connected with environments.

The trigger valve includes a shuttle valve 4 driven by compressed high pressure air in the chamber 11. The shuttle valve 4 includes three air tight rings 4a, 4b, 4c, to form an upper valve stopper 41, a middle valve stopper 42, and a bottom valve stopper 43. In this illustrated embodiment, the upper valve stopper 41 has a diameter less than that of the middle valve stopper 42, and the middle valve stopper 42 has a diameter less than or equal to that of the bottom valve stopper 43. The shuttle valve 4 is nested to the valve body 2 from top to bottom, so as to divide the air groove 20 into a first air inputting passage 20a connecting with the chamber 11 and the main air passage 12, a second air inputting passage 20b connecting with the chamber 11 and the bottom valve hole 31, a first air exhausting passage 20c connecting with the air exhausting groove 32 and the main air passage 12, and a second air exhausting passage 20d connecting with the environments via the bottom valve hole 31.

The upper valve stopper 41 can control the top valve hole 21 to open or close the first air inputting passage 20a, and the middle valve stopper 42 can control the middle valve hole 22 to open or close the first air exhausting passage 20c.

The bottom valve stopper 43 can nest an inner wall 33 of the valve base 3, for dividing the air groove 20 into a bottom air chamber 23, which is connected with environments via the bottom valve hole 31. The shuttle valve 4 includes a step hole 44 connecting between the chamber 11 and the bottom air chamber 23. The step hole 44 includes an upward shoulder surface 45.

The trigger valve includes a valve bar 5, which is capable of being pressed and released. The valve bar 5 is nested between the bottom valve hole 31 and the step hole 44 of the shuttle valve 4. The valve bar 5 shapes as step column, and has a downward shoulder surface 51. The valve bar 5 includes at least one air tight ring 5a disposed at a larger cylinder surface, which is moved between the bottom valve hole 31 and the step hole 44. With these configurations, the valve bar 5 can control the bottom valve hole 31 to open or close, so as to open or close the second air exhausting passage 20d. The valve bar 5 also can control the step hole 44 to open or close, so as to open or close the second air inputting passage 20b.

The trigger valve includes a spring 6 abutted between the shoulder surface 51 of the valve bar 5 and the shoulder surface 45 of the shuttle valve 4, to assist in keeping the valve bar 5 in a down position when the trigger is not pressed or is released.

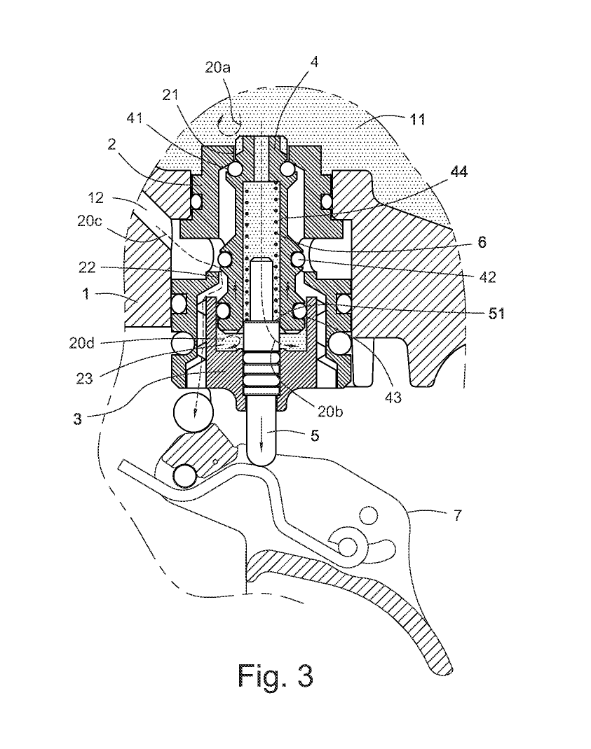

In operation, before the trigger 7 is manipulated as shown in FIG. 3, the air chamber 11 concentrates high pressure air and maintains a certain pressure therein. The high pressure air are guided into the step hole 44 to drive the valve bar 5, to keep the valve bar 5 downwardly move to close the second air exhausting passage 20d and open the second air inputting passage 20b. The spring 6 is assisted in driving the valve bar 5 downwardly to move to this position. At this time, the high pressure air in the chamber 11 are continuously guided into the bottom chamber 23 via the second air inputting passage 20b. Because the bottom valve stopper 43 has a diameter larger than that of the upper valve stopper 41, the compressed high pressure air in the bottom chamber 23 can drive the shuttle valve 4 upwardly move, to actuate the upper valve stopper 41 to close the upper valve hole 21 and the first air inputting passage 20a. Then the high pressure air in the chamber 11 are prevented from fluiding into the main air passage 12. The middle valve stopper 42 open the middle valve hole 22 and the first air exhausting passage 20c, to actuate the main air passage 12 to connect with environments for exhausting air therein.

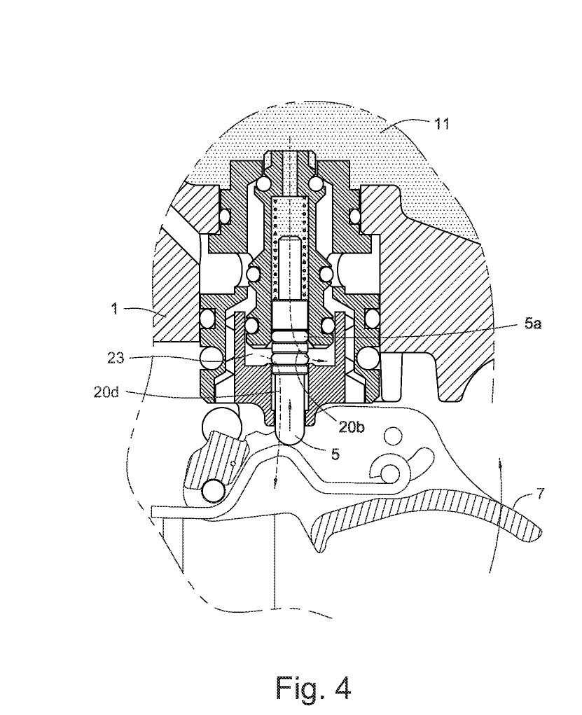

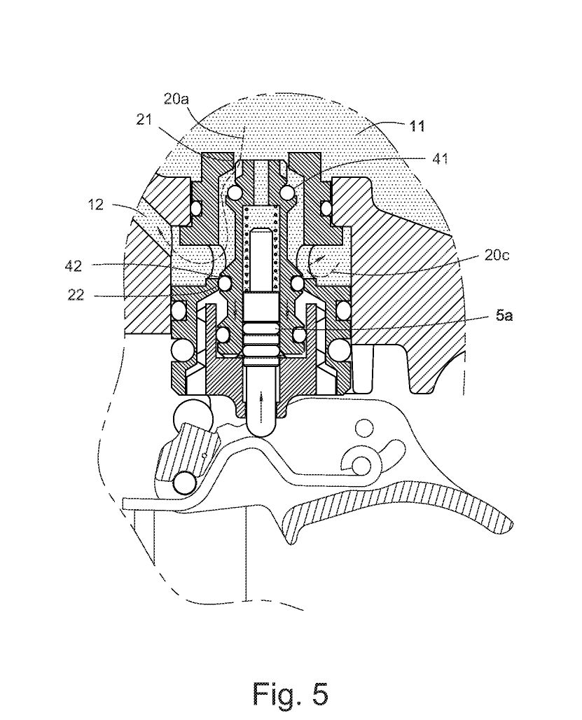

Referring to FIG. 4, when the trigger 7 is pressed to drive the valve bar to upwardly move, the valve bar 5 may move upwardly to close the second air inputting passage 20b, to prevent the high pressure air in the chamber 11 from being guided into the bottom chamber 23. The valve bar 5 also open the second air exhausting passage 20d to exhaust the high pressure air in the bottom chamber 23. At this time, the shuttle valve 4 has no force to drive it upwardly move, the high pressure air in the chamber 11 can drive the shuttle valve 4 to rapidly downwardly move to certain position (as shown in FIG. 5). The middle valve stopper 42 can close the middle valve hole 22 and the first air exhausting passage 22c to prevent the main air passage 12 from exhausting air. The upper valve stopper 41 can open the top valve hole 21 and the first air inputting passage 20a to continuously guide high pressure air to transmit from the chamber 11 to the main air passage 12, for assisting in providing necessary energy for hitting nails, so as to increase the agility of the trigger valve during the process of hitting nails.

Then, when the user releases the trigger 7, the valve bar 5 and the shuttle valve 4 can reposit to original positions before the trigger 7 is manipulated as shown in FIG. 3. Then, the trigger 7 is ready to be manipulated again.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A trigger valve of a pneumatic nail gun, the nail gun comprising an air concentrating chamber and a main air passage, the trigger valve, comprising:
a valve body disposed between the air concentrating chamber and the main air passage, the valve body forming an air groove therein;
a valve base fixed to or integrated with a bottom portion of the valve body, the valve base comprising a bottom valve hole and at least one air exhausting groove connected with environments;
a shuttle valve being driven by compressed high pressure air in the air concentrating chamber, the shuttle valve being nested in the valve body, to divide the air groove into a first air inputting passage connecting with the air concentrating chamber and the main air passage, a second air inputting passage connecting with the air concentrating chamber and the bottom air chamber, a first air exhausting passage connecting with the air exhausting groove and the main air passage, and a second air exhausting passage connecting with the environments via the bottom valve hole; and
a valve bar being capable of pressed and released, which being nested between the bottom valve hole and the shuttle valve;
wherein when the valve bar is driven to upwardly move to close the second air inputting passage and open the second air exhausting passage, the shuttle valve is driven to downwardly move by high pressure air in the air concentrating chamber, so as to close the first air exhausting passage and open the first air inputting passage for guiding the high pressure air in the air concentrating chamber into the main air passage; when the valve bar is released to downwardly move to close the second air exhausting passage and open the second air inputting passage, the shuttle valve is driven to upwardly move to reposit by high pressure air in the bottom air chamber via the second air inputting passage, so as to close the first air inputting passage and open the first air exhausting passage for exhausting the high pressure air in the main air passage to environments.

2. The trigger valve as claimed in claim 1, wherein the valve body comprises a top valve hole connected with the air concentrating chamber, and the shuttle valve comprises a top valve stopper disposed at an outside wall thereof, the top valve stopper controls the top valve hole to open or close the first air inputting passage.

3. The trigger valve as claimed in claim 1, wherein the valve body comprises a middle valve hole connected with the main air passage, and the shuttle valve comprises a middle valve stopper disposed at an outside wall thereof, the middle valve stopper controls the middle valve hole to open or close the first air exhausting passage.

4. The trigger valve as claimed in claim 1, wherein the shuttle valve comprises a bottom valve stopper disposed at an outside wall, to divide the air groove into a bottom air chamber, the shuttle valve comprises a step hole connecting between the air concentrating chamber and the bottom air chamber, the valve bar is nested between the bottom valve hole and the step hole of the shuttle valve 4, to control the bottom valve hole to open or close the second air exhausting passage, as well as to control the step hole to open or close the second air inputting passage.

5. The trigger valve as claimed in claim 4, wherein the step hole forms an upward shoulder surface, and the valve bar forms a downward shoulder surface, a spring is abutted between the shoulder surfaces.

6. The trigger valve as claimed in claim 1, wherein the shuttle valve comprises an upper valve stopper, a middle valve stopper, and a bottom valve stopper, the upper valve stopper has a diameter less than that of the middle valve stopper, and the middle valve stopper has a diameter less than or equal to that of the bottom valve stopper.
